(19) United States
(12) Patent Application Publication
(10) Pub. No.: US 2019/0124711 A1
(43) Pub. Date: Apr. 25, 2019

(54) METHOD AND APPARATUS FOR OBTAINING AND SENDING RESUME IDENTIFIER, UE, AND ACCESS NETWORK DEVICE

(71) Applicant: ZTE CORPORATION, Shenzhen (CN)

(72) Inventor: Qian DAI, Shenzhen (CN)

(21) Appl. No.: 16/096,777

(22) PCT Filed: Mar. 22, 2017
(86) PCT No.: PCT/CN2017/077768

§ 371 Date: Oct. 26, 2018

(30) Foreign Application Priority Data
Apr. 26, 2016 (CN) 201610266507.0

(51) Int. Cl. H04W 76/20; H04W 36/00

(52) U.S. Cl. CPC H04W 76/20; H04W 36/0055

(57) ABSTRACT

The present invention provides a method and an apparatus for obtaining and sending a resume identifier, a user equipment, an access network device, and a computer storage medium. The method comprises: obtaining a resume identifier from a first access network device before the first access network device initiates a radio resource control (RRC) connection suspension process or an RRC connection release process, the resume identifier being used for resuming an RRC connection between a user equipment and the first access network device and corresponding to context information stored locally on the first access network device.

### TECHNICAL FIELD

The disclosure relates to the field of communication, and more particularly to methods and devices for acquiring and sending a resume Identifier (ID), User Equipment (UE), an access network device and a computer storage medium.

### BACKGROUND

A present Long Term Evolution (LTE) system belongs to a wideband wireless communication system and its service object mainly includes large-volume high-traffic users. However, along with prevailing of various non-instant messaging applications, small-volume infrequent-process communication requirements occupy most of a service proportion of a communication system, such services require frequent setup of air interface connections and core network connections with a network side and a proportion of control-plane signaling consumed by them in the whole communication traffic keeps increasing, which reduces transmission efficiency of the communication system. For solving the problem, an air interface connection resume mechanism is started to be introduced into a 3rd Generation Partnership Project (3GPP) LTE protocol at present and its flow is as follows.

1: when an Evolved Node B (eNB) determines that data transmission of UE is ended and is prepared to release an air interface connection of the UE, the eNB allocates a resume tag for the UE in Radio Resource Control (RRC) connection release signaling and suspends an Access Stratum (AS) connection context of the UE.

2: when the UE is expected to reestablish an RRC connection with the eNB, the UE is not required to execute a conventional RRC connection setup flow, executes an RRC connection resume flow instead and sends the resume tag allocated by the eNB before to the eNB, and the eNB retrieves and resumes the context of the UE according to the tag and reestablishes all bearers and security.

This flow is executed to reuse a bearer configuration and security configuration in a last RRC connection process as much as possible to avoid a bearer configuration and security configuration handshake operation being re-executed between the eNB and the UE completely through control-plane signaling during next RRC connection.

The mechanism saves signaling. However, there is still a problem about robustness of the mechanism. In case of RRC connection loss caused by some abnormal conditions occurring to the UE in a connected state, for example, an abnormal failure such as a Radio Link Failure (RLF), or handover failure or integrity check failure of the UE, the UE may be forced to reestablish the RRC connection, the RRC connection resume mechanism may not be re-executed because of no preparations and the UE may only acquire it through a conventional RRC connection reestablishment process when reestablishing the RRC connection with the eNB. Since a common cause for the abnormal failure of the UE is deterioration of wireless channel quality, a failure probability of the RRC connection reestablishment process executed under this condition is very high. According to an existing mechanism, there is only one trying chance for the RRC connection reestablishment process. After failing to reestablish the RRC connection, the UE must delete all context information and tries to set up the connection again through a conventional RRC connection setup process. This process causes the UE to repeatedly try low-success-rate connection with a network side to cause excessive signaling overhead consumption and make it impossible to execute RRC connection resume.

For the technical problems in a related art, there is yet no effective solution at present.

### SUMMARY

For solving the existing technical problems, embodiments of the disclosure provide methods and devices for acquiring and sending a resume ID, UE, an access network device and a computer storage medium.

According to an embodiment of the disclosure, there is provided a method for acquiring a resume ID, which may include that: before a first access network device initiates an RRC connection suspension process or an RRC connection release process, a resume ID is acquired from the first access network device, the resume ID being configured to resume an RRC connection between UE and the first access network device and the resume ID corresponding to context information locally pre-stored in the first access network device.

According to another embodiment of the disclosure, there is provided a method for sending a resume ID, which may include that: before an access network device initiates an RRC connection suspension process or an RRC connection release process, a resume ID is sent to UE, the resume ID being configured to resume an RRC connection between the UE and the access network device and the resume ID corresponding to context information locally pre-stored in the access network device.

According to another embodiment of the disclosure, there is provided a device for acquiring a resume ID, which may include: an acquisition module arranged to, before a first access network device initiates an RRC connection suspension process or an RRC connection release process, acquire a resume ID from the first access network device, the resume ID being configured to resume an RRC connection between UE and the first access network device and the resume ID corresponding to context information locally stored in the first access network device.

According to another embodiment of the disclosure, there is provided a device for sending a resume ID, which may include: a sending module arranged to, before an access network device initiates an RRC connection suspension process or an RRC connection release process, send a resume ID to UE, the resume ID being configured to resume an RRC connection between the UE and the access network device and the resume ID corresponding to context information locally stored in the access network device.

According to another embodiment of the disclosure, UE is provided, which may include:

a network interface; and

a processor arranged to, before a first access network device initiates an RRC connection suspension process or an RRC connection release process, acquire a resume ID from the first access network device by use of the network interface, the resume ID being configured to resume an RRC connection between the UE and the first access network device and the resume ID corresponding to context information locally stored in the first access network device.

According to another embodiment of the disclosure, an access network device is provided, which may include:

a network interface; and

a processor arranged to, before a first access network device initiates an RRC connection suspension process or an RRC connection release process, send a resume ID to UE by use of the network interface, the resume ID being configured to resume an RRC connection between the UE and the first access network device and the resume ID corresponding to context information locally stored in the access network device.

According to another embodiment of the disclosure, a computer storage medium is further provided. The computer storage medium is configured to store a program code configured to execute the operations of the methods in the abovementioned embodiments. That is, the computer storage medium includes a set of instructions. The instructions are executed to cause at least one processor to execute the method for acquiring a resume ID or execute the method for sendign a resume ID.

According to the embodiments of the disclosure, since the resume ID is acquired before the RRC connection suspension process or the RRC connection release process, the resume ID may also be acquired even if an abnormal event, for example, an RLF and a handover failure, occurs before RRC release and the RRC connection may further be subsequently resumed. Therefore, the problem in the related art that an RRC connection resume mechanism may not resume the RRC connection if the abnormal event occurs before RRC release due to the fact that the resume ID is acquired in an RRC release process is solved and robustness of the RRC connection resume mechanism is improved.

### BRIEF DESCRIPTION OF DRAWINGS

The drawings described herein are adopted to provide a further understanding to the disclosure and form a part of the application. Schematic embodiments of the disclosure and descriptions thereof are adopted to explain the disclosure. In the drawings:

FIG. 1 is a schematic diagram of a network architecture according to an embodiment of the disclosure.

FIG. 2 is a flowchart of a method for acquiring a resume ID according to an embodiment of the disclosure.

FIG. 3 is a flowchart of a method for sending a resume ID according to an embodiment of the disclosure.

FIG. 4 is a flowchart of RRC connection resume according to a first example of the disclosure.

FIG. 5 is a flowchart of RRC connection resume according to a second example of the disclosure.

FIG. 6 is a flowchart of RRC connection resume according to a third example of the disclosure.

FIG. 7 is a flowchart of RRC connection resume according to a fourth example of the disclosure.

FIG. 8 is a flowchart of RRC connection resume according to a fifth example of the disclosure.

FIG. 9 is a structure block diagram of a device for acquiring a resume ID according to an embodiment of the disclosure.

FIG. 10 is a structure block diagram of a device for sending a resume ID according to an embodiment of the disclosure.

FIG. 11 is a hardware structure block diagram of UE according to an embodiment of the disclosure.

FIG. 12 is a hardware structure block diagram of an access network device according to an embodiment of the disclosure.

### DETAILED DESCRIPTION

The disclosure will be described below with reference to the drawings and in combination with the embodiments in detail. It is to be noted that the embodiments in the application and characteristics in the embodiments may be combined without conflicts.

It is to be noted that terms “first”, “second” and the like in the specification, claims and drawings of the disclosure are adopted not to describe a specific sequence or order but to distinguish similar objects.

### First Embodiment

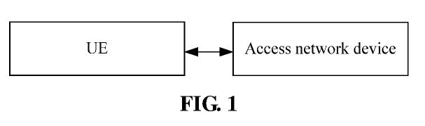

The embodiment of the application may run on a network architecture shown in FIG. 1. As shown in FIG. 1, the network architecture includes an access network device and UE. The access network device may interact with the UE for, not limited to, RRC connection, RRC connection reestablishment, RRC connection resume and the like.

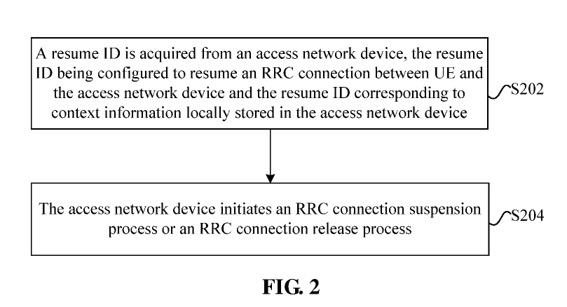

The embodiment provides a method for acquiring a resume ID, which runs on the network architecture. FIG. 2 is a flowchart of a method for acquiring a resume ID according to an embodiment of the disclosure. As shown in FIG. 2, the flow includes the following operations S202 and S204.

In S202, a resume ID is acquired from a first access network device, the resume ID being configured to resume an RRC connection between UE and the first access network device and the resume ID corresponding to context information locally stored in the first access network device.

In S204, the first access network device initiates an RRC connection suspension process or an RRC connection release process.

By the operations, since the resume ID is acquired before the RRC connection suspension process or the RRC connection release process, the resume ID may also be acquired even if an abnormal event, for example, an RLF and a handover failure, occurs before RRC release and the RRC connection may further be subsequently resumed. Therefore, the problem in the related art that an RRC connection resume mechanism may not resume the RRC connection if the abnormal event occurs before RRC release due to the fact that the resume ID is acquired in an RRC release process is solved and robustness of the RRC connection resume mechanism is improved.

It is to be noted that, according to the method, a conventional RRC connection setup process is not required to be executed for connection reestablishment after an RRC connection reestablishment failure, so that a signaling overhead is further reduced and, in addition, the RRC connection is resumed.

It is to be noted that the context information may include at least one of an AS context of the UE, a Non-Access Stratum (NAS) context of the UE, an S1 interface control-plane context or an S1 interface user-plane context.

It is to be noted that the resume ID may be acquired in at least one of the following manners: acquisition through an RRC connection setup message, acquisition through a security mode command, acquisition through an RRC connection reconfiguration message, acquisition through an RRC connection reestablishment message, acquisition through a UE capability enquiry message, acquisition through a UE information request message, acquisition through a mobility from Evolved Universal Terrestrial Radio Access (E-UTRA) command, acquisition through a Downlink (DL) information transfer message, acquisition through a newly added RRC message, acquisition through an RRC connection reestablishment denial message, or acquisition through an RRC connection denial message.

It is to be noted that, after the resume ID is acquired, the context information of the first access network device corresponding to the UE is stored and the stored context information is timely updated according to related AS and NAS configuration signaling contents transmitted by the first access network device.

In an embodiment of the disclosure, after S204, the method may further include that: an RRC connection resume request is triggered to be sent to a second access network device under at least one of the following triggering conditions, the second access network device being an access network device of a cell selected by the first access network device or by the UE: the RRC connection of the UE is released by the first access network device, the RRC connection of the UE is denied by the first access network device, an RLF occurs on the UE, a handover failure occurs on the UE, an integrity check failure occurs on the UE, an RRC connection reconfiguration failure occurs on the UE, or an RRC connection reestablishment process failure occurs on the UE.

It is to be noted that, when the triggering condition is that the RRC connection reestablishment process failure occurs on the UE, the operation that the RRC connection resume request is triggered to be sent to the second access network device includes that: information configured to indicate the RRC connection reestablishment process failure is sent to an NAS of the UE; and responsive to determining to initiate an RRC connection resume process, the NAS of the UE sends the RRC connection resume request to the second access network device. That is, when the RRC connection reestablishment process failure occurs on the UE, the UE notifies RRC reestablishment failure information to the NAS of the UE, and the NAS determines time for initiating the RRC connection resume process and, responsive to determining to initiate the RRC connection resume process, triggers the RRC connection resume request to be sent to the access network device. In such a manner, RRC reestablishment may also be performed at first according to a conventional art after another triggering condition except the triggering condition that the RRC connection reestablishment process failure occurs on the UE occurs, and the RRC connection is resumed after a reestablishment failure. Therefore, RRC connection reestablishment and RRC connection setup processes in the conventional art may further be replaced with the method.

It is to be noted that the UE reserves at least one of a resume ID acquired by the UE and allocated for the UE by each cell or context information corresponding to each cell.

In an embodiment, the method may further include that: before the RRC connection resume request is sent to the second access network device, whether the UE stores a resume ID allocated for the UE by the cell where the second access network device is located and the context information corresponding to the cell where the second access network device is located is queried.

It is to be noted that, in a handover process of the UE, the operation that the resume ID is acquired from the first access network device includes that: a resume ID allocated for the UE by a source cell is acquired from an RRC connection reconfiguration message sent from the source cell and configured to indicate handover; or, at least one of a resume ID allocated for the UE by a target cell or context information configured for the UE by the target cell is acquired from the RRC connection reconfiguration message sent from the source cell.

In an embodiment of the disclosure, the method may further include that: in a process of performing RRC connection with the target cell using the RRC connection resume process, the resume ID allocated for the UE by the source cell is sent to an access network device of the target cell; or, the resume ID allocated for the UE by the target cell is sent to the access network device of the target cell.

It is to be noted that, in the method, multiple sets of resume IDs may be allocated for the UE, which, compared with allocation of only one set of resume ID in the related art, may ensure that the resume IDs may be continued to be used without reallocation in case of handover back to the original cell.

In an embodiment of the disclosure, the method may further include that: under the condition of an RRC connection resume failure, or the RRC connection reestablishment failure or the handover failure, if signaling including indication information configured to indicate that a resume ID and context information corresponding to a present cell are required to be deleted is received from the first access network device, the resume ID and context storage corresponding to the present cell are deleted, otherwise the resume ID and the context information are stored and the UE is kept in a suspended state; or, under the condition of the RRC connection resume failure, the RRC connection reestablishment failure or the handover failure, if signaling including indication information configured to indicate that the resume ID and context information corresponding to the present cell are required to be suspended or kept is received from the first access network device, the resume ID and context storage corresponding to the present cell are continued to be stored and the UE is kept in the suspended state, otherwise the resume ID and context information of the present cell are deleted.

The suspended state includes that the context storage of the UE in the present cell is kept but the RRC connection of the UE is released.

The signaling includes at least one of an RRC connection resume denial message, an RRC connection resume failure message, the RRC connection reestablishment denial message or the RRC connection reconfiguration message.

In an embodiment of the disclosure, the method may further include that: a notification message is sent to the NAS of the UE, the notification message containing at least one of RRC connection resume failure information or RRC connection reestablishment failure information.

The RRC connection resume failure information includes at least one of a result or cause of the RRC connection resume failure.

The RRC connection reestablishment failure information includes at least one of a result or cause of the RRC connection reestablishment failure.

In an embodiment of the disclosure, the method may further include that: after a local storage time of the context information in the UE exceeds a predetermined time, at least one of the resume ID or the context information is deleted; or, when a movement location of the UE goes beyond a predetermined area coverage corresponding to a specified cell, at least one of a resume ID allocated for the UE by the specified cell or context information is deleted; or, when a number of at least one of the resume ID or context information stored in the UE exceeds a predetermined number, at least one of the resume ID allocated for the UE by the specified cell or the context information corresponding to the specified cell is deleted, or at least one of a resume ID allocated for the UE by a new cell or context information corresponding to the new cell is not stored any more, the specified cell being a cell of which a utilization frequency for the UE is lower than a predetermined frequency; or, when a storage space of the UE, which is configured to store at least one of the resume ID or the context information, exceeds a predetermined capacity, at least one of the resume ID allocated for the UE by the specified cell or the context information corresponding to the specified cell is deleted, or, at least one of the resume ID allocated for the UE by the new cell or the context information corresponding to the new cell is not stored any more, the specified cell being the cell of which the utilization frequency for the UE is lower than the predetermined frequency.

It is to be noted that the condition that the movement location of the UE goes beyond the predetermined area coverage corresponding to the specified cell includes at least one of that: the UE and the specified cell are not in a same Tracking Area (TA); the UE and the specified cell are not in a same Location Area (LA); the UE and the specified cell are not in a same Routing Area (RA); the specified cell is not in a habitual movement range of the UE, herein the habitual movement range is a cell that the UE passes by or connects to for a number of times exceeding a predetermined number of times; or a distance between a present location of the UE and the specified cell exceeds a predetermined threshold value.

It is to be noted that an execution body of the method may be, but not limited to, the UE.

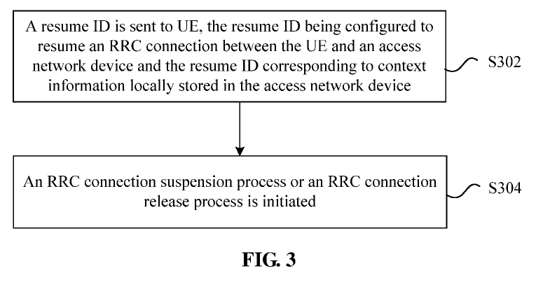

The embodiment also provides a method for sending a resume ID, which runs on the network architecture. FIG. 3 is a flowchart of a method for sending a resume ID according to an embodiment of the disclosure. As shown in FIG. 3, the flow includes the following operations S302 and S304.

In S302, a resume ID is sent to UE, the resume ID being configured to resume an RRC connection between the UE and an access network device and the resume ID corresponding to context information locally stored in the access network device.

In S304, an RRC connection suspension process or an RRC connection release process is initiated.

By the operations, since the resume ID is acquired before the RRC connection suspension process or the RRC connection release process, the resume ID may also be sent to the UE even if an abnormal event, for example, an RLF and a handover failure, occurs before RRC release and the RRC connection may further be subsequently resumed. Therefore, the problem in the related art that an RRC connection resume mechanism may not resume the RRC connection if the abnormal event occurs before RRC release due to the fact that the resume ID is acquired in an RRC release process is solved and robustness of the RRC connection resume mechanism is improved.

It is to be noted that, according to the method, a conventional RRC connection setup process is not required to be executed for connection reestablishment after an RRC connection reestablishment failure, so that a signaling overhead is further reduced and, in addition, the RRC connection is resumed.

It is to be noted that the context information may include at least one of an AS context of the UE, an NAS context of the UE, an S1 interface control-plane context or an S1 interface user-plane context.

In an embodiment of the disclosure, the resume ID may be sent to the UE through at least one of: sending through an RRC connection setup message, sending through a security mode command, sending through an RRC connection reconfiguration message, sending through an RRC connection reestablishment message, sending through a UE capability enquiry message, sending through a UE information request, sending through a mobility from E-UTRA command, sending through a DL information transfer message, sending through a newly added RRC message, sending through an RRC connection reestablishment denial message, or sending through an RRC connection denial message.

In an embodiment, before the operation that the resume ID is sent to the UE, the method further includes that: at least one of the following IDs is sent to a Mobility Management Entity (MME): the resume ID, an ID configured to identify that the access network device has set up or suspended a context storage of the UE, or an ID configured to identify that the MME is required to set up or suspend the context storage of the UE.

It is to be noted that, before S302 is executed, the method may further include at least one of the following operations: in an X2-interface-based handover process, an access network device of a source cell sends a handover request to a target cell, the handover request including a resume ID allocated by the source cell for the UE to be handed over; in the X2-interface-based handover process, an access network device of the target cell sends a handover request Acknowledge (ACK) to the source cell, the handover request ACK including a resume ID allocated by the target cell for the UE to be handed over; in an b-interface-based handover process, the access network device of the source cell sends a handover required message to the MME, the handover required message including the resume ID allocated by the source cell for the UE to be handed over; in the S1-interface-based handover process, the access network device of the target cell acquires the resume ID allocated by the source cell for the UE to be handed over from the handover request sent from the MME; in the S1-interface-based handover process, the access network device of the target cell sends the handover request ACK to the MME through an S1 interface, the handover request ACK including the resume ID allocated by the target cell for the UE to be handed over; in the S1-interface-based handover process, the access network device of the source cell acquires the resume ID allocated by the target cell for the UE to be handed over from a handover command sent from the MME; in the X2-interface-based or S1-interface-based handover process, the access network device of the source cell forwards the resume ID allocated for the UE by the target cell to the UE through the RRC connection reconfiguration message configured to indicate handover; or in the X2-interface-based or S1-interface-based handover process, the access network device of the source cell sends the resume ID allocated by the source cell to the UE through the RRC connection reconfiguration message configured to indicate handover.

In an embodiment of the disclosure, in the X2-interface-based or S1-interface-based handover process, the method may further include that: in the X2-interface-based handover process, the handover request ACK sent from the access network device of the target cell is received, the handover request ACK including context information configured for the UE by the target cell, and the context inform configured for the UE by the target cell is forwarded to the UE through the RRC connection reconfiguration message configured to indicate handover; and in the S1-interface-based handover process, the handover command sent from the MME is received to acquire the context information configured for the UE by the target cell and the context information configured for the UE by the target cell is forwarded to the UE through the RRC connection reconfiguration message configured to indicate handover, the MME acquiring the context information configured for the UE by the target cell through the handover request ACK sent from the access network device of the target cell.

In an embodiment of the disclosure, after S304, the method may further include that: an RRC connection resume request sent from the UE is received; it is determined whether the resume ID is a resume ID allocated for the UE by a present cell; if YES, contexts pre-stored in the access network device are searched for the context information corresponding to the UE; and if NO, the context information corresponding to the resume ID is requested through an X2 interface or the S1 interface from a cell allocating the resume ID.

In an embodiment of the disclosure, the method may further include that: under the condition of an RRC connection resume failure, an RRC connection reestablishment failure or a handover failure, the resume ID and context information corresponding to the UE are stored and the UE is kept in a suspended state, the suspended state including that the RRC connection of the UE is released but the context information of the UE is stored; or, under the condition of the RRC connection resume failure, the RRC connection reestablishment failure or the handover failure, a suspension indication or a context storage reservation indication is included in signaling sent to the UE to require the UE to continue storing the resume ID and context storage corresponding to the present cell and the UE is kept in the suspended state, the signaling including at least one of an RRC connection resume denial message, an RRC connection resume failure message, the RRC connection reestablishment denial message or the RRC connection reconfiguration message.

In an embodiment of the disclosure, under the condition of the RRC connection resume failure, or the RRC connection reestablishment failure or the handover failure, the signaling is sent to notify the UE to delete the resume ID and context storage corresponding to the present cell and the resume ID and context storage locally stored in the access network device and corresponding to the UE are simultaneously deleted. The signaling includes at least one of the RRC connection resume denial message, the RRC connection resume failure message, the RRC connection reestablishment denial message or the RRC connection reconfiguration message.

It is to be noted that an execution body of the method may be the access network device and the access network device may be, but not limited to, the access network device of the source cell and the access network device of the target cell.

For better understanding the disclosure, the disclosure will be further explained below in combination with specific embodiments.

For solving the technical problem, an embodiment of the disclosure provides an RRC connection resume method, which includes the following operations. The embodiment of the disclosure provides a specific RRC connection resume method, which includes that: UE acquires a resume ID from an access network device side, the resume ID corresponding to an AS context and NAS context of the UE and S1 interface control-plane and S1 interface user-plane contexts, which are stored in a network-side device.

It is to be noted that the UE acquires the resume ID before the access network device initiates an RRC connection suspension process or an RRC connection release process.

In the specific embodiment, the UE, after receiving the resume ID, should set up storage of its own AS context and NAS context and timely update the storage according to related AS and NAS configuration signaling contents transmitted by the access network device.

In the specific embodiment, when one of the following events occurs: an RRC connection of the UE is released by the access network device, or the RRC connection of the UE is denied by the access network device, an RLF occurs on the UE, a handover failure occurs on the UE, an integrity check failure occurs on the UE and an RRC connection reconfiguration failure occurs on the UE, the UE may initiate an RRC connection resume process in a present cell and send the resume ID to the access network device of the cell in this process. Specifically, the UE sends the resume ID to the access network device of the cell through an RRC connection resume message.

In the specific embodiment, after the abovementioned events occur, RRC reestablishment is performed at first according to the conventional art and the RRC connection is resumed after a reestablishment failure. That is, the RRC connection resume method is taken as a second-layer protection measure. When the UE initiates RRC connection reestablishment and fails in reestablishment, the UE notifies RRC connection reestablishment failure information to an NAS of the UE and the NAS of the UE determines a time for initiating an RRC connection resume process. Responsive to determining, by the NAS of the UE, to initiate the RRC connection resume process, the UE sends the resume ID to an access network device of a target cell in the RRC connection resume process.

In the specific embodiment, in a handover process of the UE, the UE acquires a resume ID allocated for the UE by a source cell from the RRC connection reconfiguration message sent from the source cell and configured to indicate handover. Or, in the handover process of the UE, the UE acquires a resume ID allocated for the UE by the target cell and/or context information configured for the UE by the target cell from the RRC connection reconfiguration message sent from the source cell and configured to indicate handover.

In the specific embodiment, in the handover process of the UE, the method further includes that: the UE, after receiving the RRC connection reconfiguration message sent from the source cell and configured to indicate handover, initiates the RRC connection resume process in the target cell and sends the resume ID allocated for the UE by the target cell to the access network device of the target cell in the RRC connection resume process; or, the UE, after receiving the RRC connection reconfiguration message sent from the source cell and configured to indicate handover, initiates the RRC connection resume process in the target cell and sends the resume ID allocated for the UE by the source cell to the access network device of the target cell in the RRC connection resume process.

In the specific embodiment, if the UE fails in RRC connection resume or the UE fails in RRC connection reestablishment, both of the UE and an eNB should continue storing the resume ID and context storage corresponding to the UE and the UE is kept in a suspended state. The suspended state refers to that a context storage state of the UE is kept but the RRC connection of the UE is released.

In the specific embodiment, if the UE fails in RRC connection resume or the UE fails in RRC connection reestablishment, a processing method for the UE further includes that: an AS of the UE should notify a result and cause of an RRC connection resume failure or an RRC connection reestablishment failure to a high layer, i.e., the NAS, of the UE.

In the specific embodiment, the UE, before the access network device initiates the RRC connection suspension process or the RRC connection release process, acquires the resume ID from the access network device, specifically in the following manners: the UE acquires the resume ID from a message 4 or an RRC setup message; the UE acquires the resume ID from a security mode command; the UE acquires the resume ID from an RRC connection reconfiguration message; the UE acquires the resume ID from an RRC connection reestablishment message; the UE acquires the resume ID from a UE capability enquiry message; the UE acquires the resume ID from a UE information request; the UE acquires the resume ID from a mobility from EUTRA command; and the UE acquires the resume ID from a DL information transfer message.

In the specific embodiment, the UE reserves a resume ID allocated for the UE by each cell and acquired before and a context storage, corresponding to each cell, of the UE. In an embodiment, a reservation method further includes that: the UE reserves the resume ID allocated for the UE by each cell and acquired before and the context storage, corresponding to each cell, of the UE, but the UE sets a timer and a unified time limit for the resume ID and context storage corresponding to each cell and, when the timer corresponding to a certain cell exceeds the time limit, the UE deletes the resume ID and context storage corresponding to the cell; and the UE reserves the resume ID allocated for the UE by each cell and acquired before and the context storage, corresponding to each cell, of the UE, but the UE sets an area coverage limit for each cell and, when a movement location of the UE exceeds the area coverage limit corresponding to a certain cell, the UE deletes the resume ID and context storage corresponding to the cell. The area coverage limit may include the following forms: whether they are in the same TA, that is, when the UE and a certain cell are not in a same TA, the UE deletes the resume ID and context storage corresponding to the cell; whether they are in the same LA, that is, when the UE and a certain cell are not in a same LA, the UE deletes the resume ID and context storage corresponding to the cell; whether they are in the same RA, that is, when the UE and a certain cell are not in a same RA, the UE deletes the resume ID and context storage corresponding to the cell; whether the cell is in a habitual movement range of the UE, that is, the UE makes statistics on cells it frequently passes by or is connected and defines these cells as its habitual movement range and, if a certain cell is not in its habitual movement range, the UE deletes the resume ID and context storage corresponding to the cell; a distance limit, which may be defined as a spaced cell number or an absolute geographic distance, that is, when a distance between a present location of the UE and a certain cell exceeds the distance limit, the UE deletes the resume ID and context storage corresponding to the cell; and a storage number limit or a storage capacity limit, that is, when the UE stores resume IDs and contexts of a limited number of cells or a storage capacity arranged to store the resume IDs and the contexts, of the UE reaches the capacity limit, the UE does not store a resume ID and context of a new cell any more or the UE deletes the resume ID and context of the cell of which a utilization rate is minimum to store the resume ID and context of the new cell.

In the specific embodiment, before the UE is prepared to initiate the RRC connection resume process in a certain cell, the UE queries whether it reserves a resume ID allocated by the cell and a context storage corresponding to the cell, and if YES, the UE uses the resume ID allocated by the cell and the context storage corresponding to the cell for RRC connection resume.

It is to be noted that an execution body of the operations in the specific embodiment may be, but not limited to, the UE.

The specific embodiment of the disclosure also provides an RRC connection resume method, which includes that: an access network device sends a resume ID to UE, the resume ID corresponding to an AS context and NAS context of the UE and S1 interface control-plane and S1 interface user-plane contexts, which are stored in a network-side device.

In the specific embodiment of the disclosure, the access network device sends the resume ID to the UE before initiating an RRC connection suspension process or an RRC connection release process.

In the specific embodiment of the disclosure, the access network device should set up a storage of the AS context and NAS context of the UE at the same time of allocating the resume ID for the UE and, if subsequently modifying a related AS or NAS configuration of the UE, is required to timely update a modified content into the context storage of the UE.

In the specific embodiment of the disclosure, when the access network device receives a resume ID sent by the UE in an RRC connection resume process initiated by the UE, the access network device determines the specific cell which allocates the resume ID for the UE. If it is allocated by a present cell, the access network device finds a context of the UE in UE contexts stored by it, reestablishes a bearer and security of the UE according to the context and feeds back an RRC connection resume complete message to the UE. If the resume ID is allocated by another cell, the access network device requests a UE context corresponding to the resume ID through an X2 interface or an S1 interface from the cell allocating the resume ID, reestablishes the bearer and security of the UE and feeds back the RRC connection resume complete message to the UE.

In the specific embodiment of the disclosure, if RRC connection resume initiated by the UE fails or the UE fails in RRC connection reestablishment, both of the UE and the access network device should continue storing the resume ID and context storage corresponding to the UE and the access network device keeps a context storage state of the UE.

In the specific embodiment of the disclosure, the access network device, before initiating the RRC connection suspension process or the RRC connection release process, sends the resume ID, specifically in the following manners: the resume ID is sent to the UE through a message 4 or an RRC connection setup message; the resume ID is sent to the UE through a security mode command; the resume ID is sent to the UE through an RRC connection reconfiguration message; the resume ID is sent to the UE through an RRC connection reestablishment message; the resume ID is sent to the UE through a UE capability enquiry message; the resume ID is sent to the UE through a UE information request; the resume ID is sent to the UE through a mobility from EUTRA command; and the resume ID is sent to the UE through a DL information transfer message.

In an X2-interface-based handover process, an access network device of a source cell includes a resume ID allocated by the source cell for the UE to be handed over in a handover request sent to a target cell. In the X2-interface-based handover process, an access network device of the target cell includes a resume ID allocated by the target cell for the UE to be handed over in a handover request ACK sent to the source cell. In an S1-interface-based handover process, the access network device of the source cell includes the resume ID allocated by the source cell for the UE to be handed over in a handover required message sent to an MME (it is to be noted that the handover required message and the handover request are different in terms of name but are substantially similar, and just because English names adopted in standards are different, different Chinese names are adopted herein). In the S1-interface-based handover process, the access network device of the target cell acquires the resume ID allocated by the source cell for the UE to be handed over from the handover request sent from the MME. In the S1-interface-based handover process, the access network device of the target cell includes the resume ID allocated by the target cell for the UE to be handed over in the handover request ACK sent to the MME through an S1 interface. In the S1-interface-based handover process, the access network device of the source cell acquires the resume ID allocated by the target cell for the UE to be handed over from a handover command sent from the MME. In the X2-interface-based or S1-interface-based handover process, the access network device of the source cell forwards the resume ID (TargetCellResumeID) allocated for the UE by the target cell to the UE through the RRC connection reconfiguration message configured to indicate handover. In the X2-interface-based or S1-interface-based handover process, the access network device of the source cell sends the resume ID (Source Cell Resume ID) allocated by the source cell to the UE through the RRC connection reconfiguration message configured to indicate handover.

In the specific embodiment of the disclosure, in the X2-interface-based or S1-interface-based handover process, the method further includes that: in the X2-interface-based handover process, the access network device of the target cell includes context information configured for the UE by the target cell in the handover request ACK sent to the access network device of the source cell and the access network device of the source cell forwards the context information configured for the UE by the target cell through the RRC connection reconfiguration message sent to the UE and configured to indicate handover; and in the S1-interface-based handover process, the access network device of the target cell includes the context information configured for the UE by the target cell in the handover request ACK sent to the MME, the MME forwards the context information configured for the UE by the target cell through the handover command sent to the access network device of the source cell and the access network device of the source cell forwards the context information configured for the UE by the target cell through the RRC connection reconfiguration message sent to the UE and configured to indicate handover.

All of the following examples are for an LTE system scenario.

### First Example

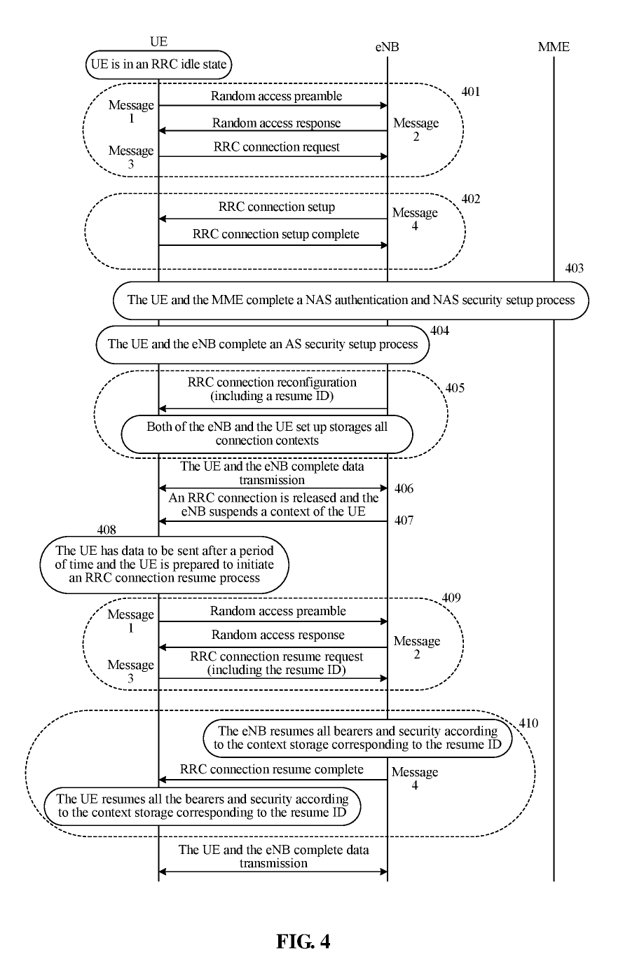

An example that UE acquires a resume ID and initiates RRC connection resume in an RRC idle state is described in the embodiment. FIG. 4 is a flowchart of RRC connection resume according to a first example of the disclosure, as shown in FIG. 4.

The scenario: the UE is in the idle state and stores no resume ID and the UE is prepared to set up an RRC connection with a cell where it is located. As shown in FIG. 4, the method includes the following operations 401 to 410.

In 401, the UE initiates an RRC connection setup process, completes random access preamble sending and response through a message 1 and a message 2 and sends an RRC connection setup request to an eNB (base station) through a message 3.

In 402, the eNB feeds back an RRC connection setup message to the UE through a message 4 and the UE feeds back an RRC connection setup complete message to the eNB through a message 5.

In 403, the UE and an MME (core network device) complete an NAS authentication and NAS security setup process.

In 404, the UE and the eNB complete an AS security setup process.

In 405, the eNB sends an RRC connection reconfiguration message to the UE, the resume ID being included. Both of the eNB and the UE set up storages of all connection contexts of the UE, including an AS context, an NAS context and control-plane and user-plane contexts of an S1 interface (interface between the eNB and the MME).

In 406, the UE and the eNB complete data transmission.

In 407, the eNB initiates an RRC suspension process to suspend the context of the UE, suspension referring to that a context storage state of the UE is kept but an RRC connection of the UE is released.

In 408, the UE has data to be sent after a period of time and is prepared to set up the RRC connection with a network side, and in such case, the UE may initiate an RRC connection resume process because of the suspended context.

In 409, the UE initiates the RRC connection resume process, completes random access preamble sending through the message 1 and the message 2 and sends an RRC connection resume request to the eNB through the message 3, the RRC connection resume request including the resume ID transmitted before by the eNB.

In 410, the eNB feeds back an RRC connection resume complete message to the UE through a message 4, and the UE and the eNB reestablish all bearers and security according to the context storage corresponding to the resume ID respectively.

In the embodiment, the eNB transmits the resume ID to the UE through the RRC connection reconfiguration message and may further transmit the resume ID to the UE through the following signaling.

The resume ID is sent to the UE through the message 4.

The resume ID is sent to the UE through a security mode command.

The resume ID is sent to the UE through an RRC connection setup message.

The resume ID is sent to the UE through an RRC connection reestablishment message.

The resume ID is sent to the UE through a UE capability enquiry message.

The resume ID is sent to the UE through a UE information request.

The resume ID is sent to the UE through a mobility from EUTRA command.

The resume ID is sent to the UE through a DL information transfer message.

The RRC connection reestablishment message is as follows. When the UE initiates an RRC connection reestablishment process, the eNB, after receiving an RRC connection reestablishment request of the UE, feeds back the RRC connection reestablishment message to the UE if allowing the UE to perform RRC connection reestablishment and the resume ID may be included in the RRC connection reestablishment message.

### Second Example

An example that UE acquires a resume ID and, after an RLF occurs on the UE, or a handover failure occurs, or an integrity check failure occurs or an RRC connection reconfiguration failure occurs, initiates RRC connection resume in a manner of directly initiating RRC connection resume is described in the embodiment.

When one of the events occurs, the UE may initiate an RRC connection resume process in a target cell according to the target cell selected by it or according to the target cell specified in a handover command and send the resume ID to an access network device of the target cell in this process. Specifically, the UE sends the resume ID to the access network device of the target cell through an RRC connection resume message.

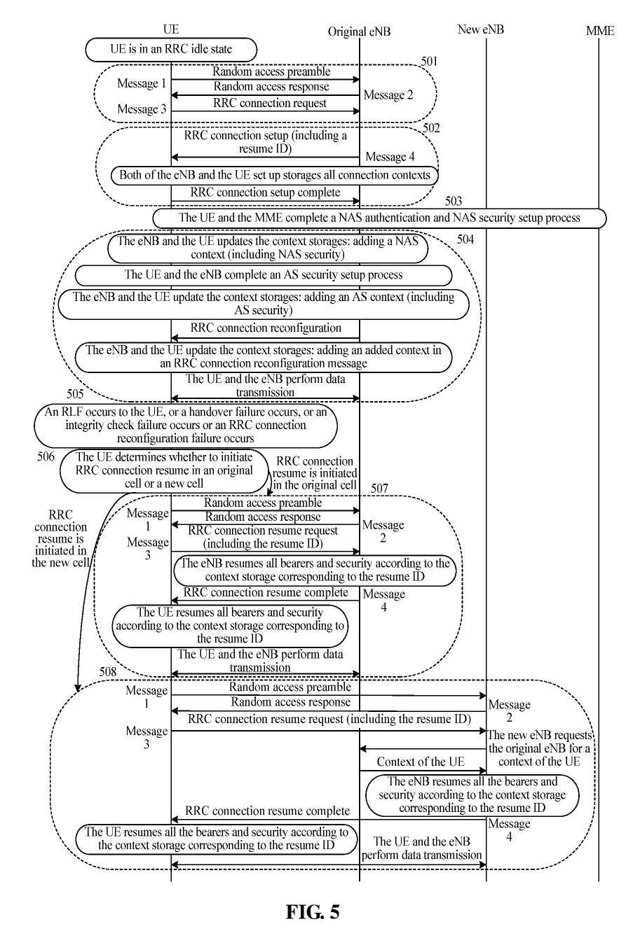

FIG. 5 is a flowchart of RRC connection resume according to a second example of the disclosure. As shown in FIG. 5, the flow includes the following operations 501 to 508.

At first, the UE is in an RRC idle state and is prepared to set up an RRC connection with a network side because there is data to be transmitted.

In 501, the UE initiates an RRC connection setup process, completes random access preamble sending and response through a message 1 and a message 2 and sends an RRC connection setup request to an original eNB (base station) through a message 3.

In 502, the original eNB feeds back an RRC connection setup message to the UE through a message 4, a resume ID allocated for the UE by the original eNB being included. In such case, the eNB sets up a storage of all connection contexts of the UE and the UE, after receiving the resume ID, also sets up a storage of all the connection contexts. The UE feeds back an RRC connection setup complete message to the original eNB.

In 503, the UE and an MME (core network device) complete an NAS authentication and NAS security setup process.

In 504, the eNB and the UE update the storage of the contexts: adding an NAS context (including NAS security). Then, the UE and the eNB complete an AS security setup process and the eNB and the UE update the storage of the contexts: adding an AS context (including AS security). After NAS and AS security setup is completed, the eNB sends an RRC connection reconfiguration message to the UE to setup a data bearer and the UE, after receiving it, sets up the data bearer accordingly and then may perform data transmission with the eNB. The eNB and the UE synchronously update the storage of the contexts: adding a newly added context in the RRC connection reconfiguration message.

In 505, when an event such as an RLF, or a handover failure, or an integrity check failure or an RRC connection reconfiguration failure occurs on the UE, the following flow is executed.

In 506, the UE determines whether to initiate RRC connection resume in an original cell (also called a source cell) or a new cell (also called a target cell). If the UE does not move out of the original cell, RRC connection resume is initiated in the original cell, that is, 507 is entered. Otherwise RRC connection resume is initiated in the new cell, that is, 508 is entered.

Notes: names of the source cell and the target cell are usually used in a handover process and their meanings are similar to the original cell and the new cell. In the embodiment, handover is not executed, so the names of the original cell and the new cell are adopted. In English, both of the original cell and the source cell may be called original cell or source cell and both of the new cell and the target cell may be called new cell or target cell.

In 507, the UE initiates the RRC connection resume process in the original cell, completes random access preamble sending and response through the message 1 and the message 2 and sends an RRC connection resume request to the original eNB through the message 3, the resume ID allocated for the UE by the original eNB being included. The original eNB resumes all bearers and security of the UE according to the context storage corresponding to the resume ID. Then, the original eNB feeds back an RRC connection resume complete message to the UE, the UE accordingly determines that its RRC connection resume request is acknowledged by the original eNB, the UE resumes all the bearers and security according to the context storage corresponding to the resume ID, and then the UE and the original eNB perform data transmission.

In 508, the UE initiates the RRC connection resume process in the new cell, completes random access preamble sending and response through the message 1 and the message 2 and sends the RRC connection resume request to a new eNB through the message 3, the resume ID allocated for the UE by the original eNB being included. The new eNB determines the eNB allocating the resume ID according to the resume ID and then requests the context of the UE corresponding to the resume ID from the original eNB allocating the resume ID. The original eNB feeds back the context, corresponding to the resume ID, of the UE to the new eNB. The new eNB resumes all the bearers and security of the UE according to the received context storage corresponding to the UE. Then, the new eNB feeds back the RRC connection resume complete message to the UE, the UE accordingly determines that its RRC connection resume request is acknowledged by the new eNB, the UE resumes all the bearers and security according to the context storage corresponding to the resume ID and then the UE and the eNB perform data transmission.

In the embodiment, in 502, the eNB transmits the resume ID to the UE through the message 4, i.e., an RRC connection setup message, and may further transmit the resume ID to the UE through the following signaling.

The resume ID is sent to the UE through a security mode command.

The resume ID is sent to the UE through an RRC connection reestablishment message.

The resume ID is sent to the UE through the RRC connection reconfiguration message.

The resume ID is sent to the UE through a UE capability enquiry message.

The resume ID is sent to the UE through a UE information request.

The resume ID is sent to the UE through a mobility from EUTRA command.

The resume ID is sent to the UE through a DL information transfer message.

### Third Example

An example about acquisition of a resume ID by UE and how to initiate RRC connection resume after an RLF occurs on the UE, or a handover failure occurs, or an integrity check failure occurs or an RRC connection reconfiguration failure occurs is described in the embodiment. In the embodiment, the UE initiates RRC connection reestablishment at first and, in case of a reestablishment failure, initiates RRC connection resume.

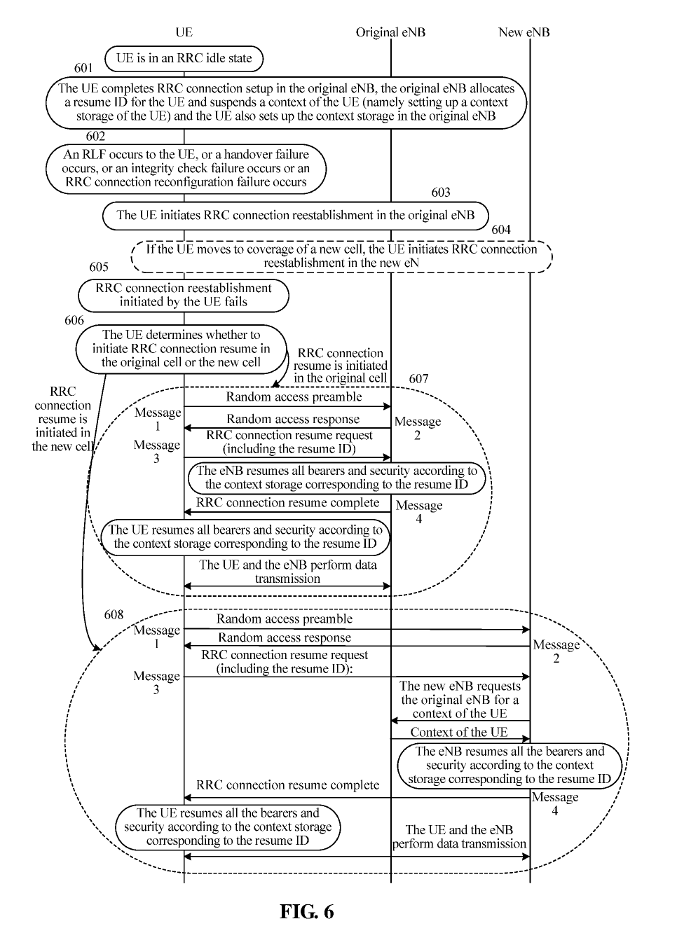

FIG. 6 is a flowchart of RRC connection resume according to a third example of the disclosure. As shown in FIG. 6, the flow includes the following operations 601 to 608.

At first, the UE is in an RRC idle state and is prepared to set up an RRC connection with a network side because there is data to be transmitted.

In 601, the UE completes RRC connection setup in an original eNB. The original eNB allocates the resume ID for the UE and suspends a context of the UE (namely setting up a context storage of the UE). The UE also establishes the context storage in the original eNB. That is, the operation may refer to 501 to 504 in the second example.

In 602, when an event such as the RLF, or the handover failure, or the integrity check failure or the RRC connection reconfiguration failure occurs on the UE, the UE is required to determine whether to execute an RRC connection reestablishment process in an original cell or a new cell, if in the original cell, enters 603 otherwise enters 604.

In 603, the UE initiates RRC connection reestablishment in the original eNB.

In 604, if the UE moves to coverage of the new cell, the UE initiates RRC connection reestablishment in a new eNB.

In 605, there is made such a hypothesis that RRC connection reestablishment initiated by the UE fails and a failure cause may be deterioration of wireless channel quality.

In 606, the UE determines whether to initiate RRC connection resume in the original cell or the new cell. If the UE does not move out of the original cell, RRC connection resume is initiated in the original cell, that is, 607 is entered. Otherwise RRC connection resume is initiated in the new cell, that is, 608 is entered.

In 607, the UE initiates the RRC connection resume process in the original cell, completes random access preamble sending and response through the message 1 and the message 2 and sends an RRC connection resume request to the original eNB through the message 3, the resume ID allocated for the UE by the original eNB being included. The original eNB resumes all bearers and security of the UE according to the context storage corresponding to the resume ID. Then, the original eNB feeds back an RRC connection resume complete message to the UE, the UE accordingly determines that its RRC connection resume request is acknowledged by the eNB, the UE resumes all the bearers and security according to the context storage corresponding to the resume ID, and then the UE and the eNB perform data transmission.

In 608, the UE initiates the RRC connection resume process in the new cell, completes random access preamble sending and response through the message 1 and the message 2 and sends the RRC connection resume request to a new eNB through the message 3, the resume ID allocated for the UE by the original eNB being included. The new eNB determines the eNB allocating the resume ID according to the resume ID and then requests the context of the UE corresponding to the resume ID from the original eNB allocating the resume ID. The original eNB feeds back the context, corresponding to the resume ID, of the UE to the new eNB. The new eNB resumes all the bearers and security of the UE according to the received context storage corresponding to the UE. Then, the new eNB feeds back the RRC connection resume complete message to the UE, the UE accordingly determines that its RRC connection resume request is acknowledged by the new eNB, the UE resumes all the bearers and security according to the context storage corresponding to the resume ID and then the UE and the eNB perform data transmission.

### Fourth Example

How to allocate resume IDs for UE by a source cell and a target cell in an X2-interface-based handover process and how to set up and RRC connection by the UE in the target cell are described in the embodiment. In the embodiment, the source cell allocates its own resume ID for the UE. During a practical application, the target cell may also allocate its own resume ID for the UE. For convenient distinction, they are named after SourceENBResumeID and TargetENBResumeID respectively.

In the handover process, the UE cuts off an RRC connection with the source cell and, when setting up the RRC connection with the target cell, uses an RRC connection resume process to set up the RRC connection with the target cell. The UE may send the SourceENBResumeID to the target cell and, in such case, the target cell may resume the RRC connection of the UE in the target cell on the basis of a context of the UE in the source cell (a configuration of the target cell may also be combined).

In an embodiment, the UE may send the TargetENBResumeID to the target cell and, in such case, the target cell may query a UE context storage corresponding to the TargetENBResumeID and resume the RRC connection of the UE in the target cell on the basis of the stored context.

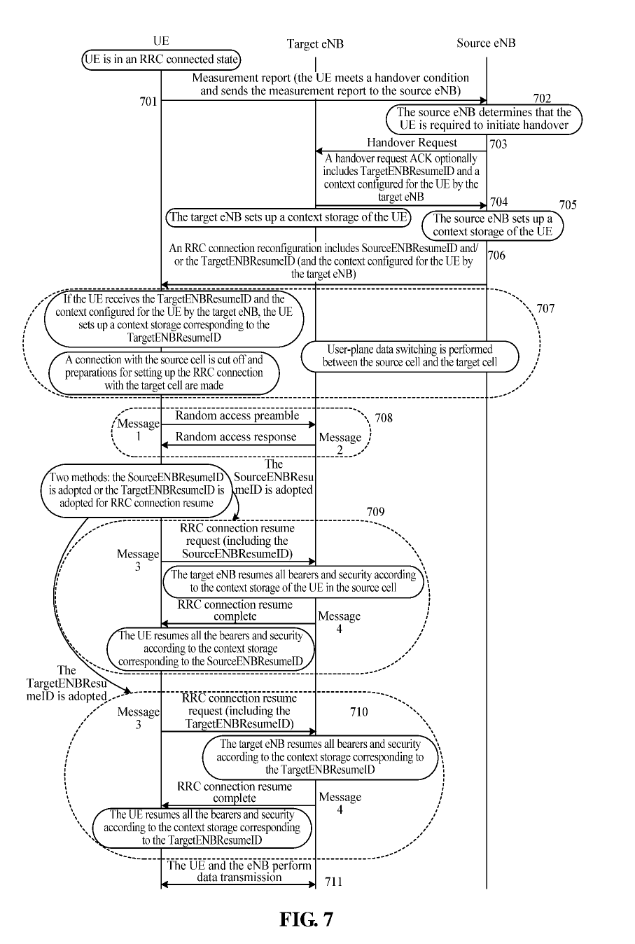

FIG. 7 is a flowchart of RRC connection resume according to a sixth example of the disclosure. As shown in FIG. 7, the flow includes the following operations 701 to 711.

At first, a state of the UE is supposed to be an RRC connected state.

In 701, if the UE moves to a handover area of two cells and a measurement result of the UE meets a handover condition, the UE is required to send a measurement report to a source eNB to assist the eNB in determining whether handover is required to be initiated.

In 702, the source eNB determines that the UE may be handed over and selects a target eNB to which the UE may be handed over.

In 703, the source eNB makes handover preparations and sends a handover request to the selected target eNB at first, the handover request including context information of the UE in the source eNB.

In 704, the target eNB, if accepting handover of the UE, feeds back a handover request ACK to the source eNB. In an embodiment, the target eNB allocates the resume ID, which may be called the TargetENBResumeID for distinction arranged for RRC resume for the UE. Meanwhile, the target eNB configures all contexts for the UE and includes the context information in the handover request ACK.

In 705, the target eNB sets up a context storage of the UE in the target eNB. The source eNB may synchronously set up a context storage of the UE in the source eNB to support RRC resume when the UE returns to the source eNB later. (Notes: there is no strict sequential relationship between the two operations of allocation of the resume ID and setup of the context storage of the UE and they may be executed at the same time and may also be executed sequentially.)

In 706, the source eNB, after receiving the handover request ACK, sends an RRC connection reconfiguration message including target eNB information for handover of the UE. In an embodiment, the message may include the resume ID, which may be called the SourceENBResumeID for distinction, allocated for the UE by the source eNB. In an embodiment, the message may include the resume ID (TargetENBResumeID) allocated for the UE by the target eNB, and the message may include the context information configured for the UE by the target eNB.

In 707, if the UE receives the TargetENBResumeID and the context configured for the UE by the target eNB, the UE sets up the context storage corresponding to the TargetENBResumeID. The UE cuts off an RRC connection with the source eNB. Meanwhile, user-plane data switching may be performed between the source eNB and the target eNB to enable the target eNB to continue service data transmission of the UE.

Next, the UE performs RRC connection resume in the target eNB. Herein, there are two methods. The UE may perform RRC connection resume in the target eNB by use of the SourceENBResumeID (referring to 409) and may also perform RRC connection resume in the target eNB by use of the TargetENBResumeID.

In 708, the UE completes uplink synchronization with the target eNB. That is, the UE sends a random access preamble to the target eNB and the target eNB feeds back a random access response to the UE to complete handshaking for uplink synchronization.

In 709, if the UE performs RRC connection resume in the target eNB by use of the SourceENBResumeID, the UE sends an RRC connection resume request to the source eNB, the SourceENBResumeID being included. The target eNB resumes all bearers and security according to the context storage of the UE in the source cell and then the target eNB feeds back an RRC connection resume complete message to the UE. The UE resumes all the bearers and security according to the context storage corresponding to the SourceENBResumeID.

In 710, if the UE performs RRC connection resume in the target eNB by use of the TargetENBResumeID, the UE sends the RRC connection resume request to the target eNB, the TargetENBResumeID being included. The target eNB resumes all the bearers and security according to the context storage corresponding to the TargetENBResumeID and then the target eNB feeds back the RRC connection resume complete message to the UE. The UE resumes all the bearers and security according to the context storage corresponding to the TargetENBResumeID.

### Fifth Example

How to allocate resume IDs for UE by a source cell and a target cell in an S1-interface-based handover process and how to set up and RRC connection by the UE in the target cell are described in the embodiment. In the embodiment, the source cell allocates its own resume ID for the UE. During a practical application, the target cell may also allocate its own resume ID for the UE. For convenient distinction, they are named after SourceENBResumeID and TargetENBResumeID respectively.

In the handover process, the UE cuts off an RRC connection with the source cell and, when setting up the RRC connection with the target cell, uses an RRC connection resume process to set up the RRC connection with the target cell. The UE may send the SourceENBResumeID to the target cell and, in such case, the target cell may resume the RRC connection of the UE in the target cell on the basis of a context of the UE in the source cell (a configuration of the target cell may also be combined).

The solutions of the embodiment and the fourth example are substantially consistent. The difference is that signaling interaction with a core network element, i.e., an MME, is required to be involved in an S1 interface handover flow. Related information of RRC resume is required to be transmitted through the MME. The difference of the flow related to the MME is mainly described in the embodiment.

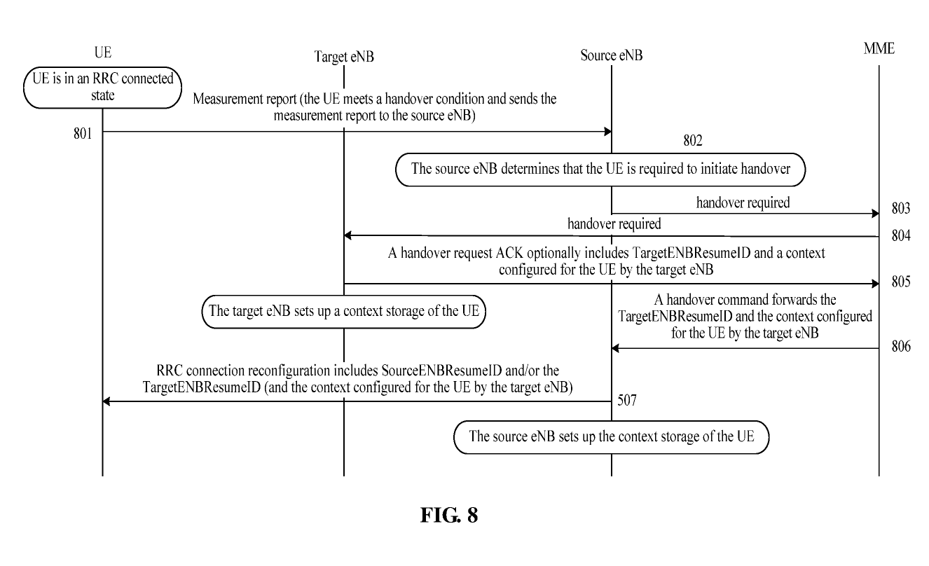

FIG. 8 is a flowchart of RRC connection resume according to a fifth example of the disclosure. As shown in FIG. 8, the flow includes the following operations 801 to 807.

At first, a state of the UE is supposed to be an RRC connected state.

In 801, if the UE moves to a handover area of two cells and a measurement result of the UE meets a handover condition, the UE is required to send a measurement report to a source eNB to assist the base station in determining whether handover is required to be initiated.

In 802, the source eNB determines that the UE may be handed over and selects a target eNB to which the UE may be handed over.

In 803, the source eNB makes handover preparations and sends a handover required message to the MME at first, the handover required message including context information of the UE in the source eNB.

In 804, the MME forwards the handover required message of the source eNB to the target eNB through a handover request.

In 805, the target eNB, if accepting handover of the UE, sends a handover request ACK to the MME. In an embodiment, the target eNB allocates the resume ID, which may be called the TargetENBResumeID for distinction arranged for RRC resume for the UE to be handed over. In addition, the target eNB configures all contexts for the UE and also includes the context information in the handover request ACK. Moreover, the target eNB sets up a context storage of the UE in the target eNB.

In 806, the MME forwards the TargetENBResumeID and the context information configured for the UE by the target eNB to the source eNB through a handover command.

In 807, the source eNB, after receiving the handover command, sends an RRC connection reconfiguration message including target eNB information for handover of the UE. In an embodiment, the message may further include the resume ID, which may be called the SourceENBResumeID for distinction, allocated for the UE by the source eNB. In an embodiment, the message may include the resume ID (TargetENBResumeID) allocated for the UE by the target eNB, and the message may further include the context information configured for the UE by the target eNB.

The source eNB may synchronously set up a context storage of the UE in the source eNB to support RRC resume when the UE returns to the source eNB later. (Notes: there is no strict sequential relationship between the two operations of allocation of the resume ID and setup of the context storage of the UE and they may be executed at the same time and may also be executed sequentially.)

How to subsequently execute an RRC resume process by the UE in the target eNB may refer to 707 to 710 of the flow of the fourth example.

### Sixth Example

When UE is in an RRC connected state, an access network device of a cell where it is located may send a resume ID allocated for the UE to the UE in the following relatively independent flows.

An eNB sends the resume ID to the UE through a UE capability enquiry message.

The eNB sends the resume ID to the UE through a UE information request.

The eNB sends the resume ID to the UE through a DL information transfer message.

In addition, during handover of the UE from an LTE access network (or called E-UTRA or an Evolved Universal Terrestrial Radio Access Network (E-UTRAN)) to another network, for example, handover to a network of Code Division Multiple Access 2000 (CDMA2000), or a Universal Mobile Telecommunications System (UMTS) or a Global System of Mobile communication (GSM), a resume ID allocated for the UE by an access network device of a source cell may be sent to the UE through a mobility from EUTRA command in the handover process. When the UE returns to an LTE cell, the UE may initiate an RRC connection resume process in the cell by use of the resume ID.

### Seventh Example

When UE receives a resume ID allocated for the UE by more than one cell, the UE may adopt the following processing methods.

A first method: the UE reserves the resume ID allocated for the UE by each cell and acquired before and a context storage, corresponding to each cell, of the UE.

A second method: the UE reserves the resume ID allocated for the UE by each cell and acquired before and the context storage, corresponding to each cell, of the UE, but the UE sets a timer and a unified time limit for the resume ID and context storage corresponding to each cell and, when the timer corresponding to a certain cell exceeds the time limit, the UE deletes the resume ID and context storage corresponding to the cell.

A third method: the UE reserves the resume ID allocated for the UE by each cell and acquired before and the context storage, corresponding to each cell, of the UE, but the UE sets an area coverage limit for each cell and, when a movement location of the UE exceeds the area coverage limit corresponding to a certain cell, the UE deletes the resume ID and context storage corresponding to the cell. The area coverage limit may include the following forms:

whether they are in a same TA, that is, when the UE and a certain cell are not in the same TA, the UE deletes the resume ID and context storage corresponding to the cell;

whether they are in a same LA, that is, when the UE and a certain cell are not in the same LA, the UE deletes the resume ID and context storage corresponding to the cell;

whether they are in a same RA, that is, when the UE and a certain cell are not in the same RA, the UE deletes the resume ID and context storage corresponding to the cell;

whether the cell is in a habitual movement range of the UE, that is, the UE makes statistics on cells it frequently passes by or is connected and defines these cells as its habitual movement range and, if a certain cell is not in its habitual movement range, the UE deletes the resume ID and context storage corresponding to the cell; and

a distance limit, which may be defined as a spaced cell number or an absolute geographic distance, that is, when a distance between a present location of the UE and a certain cell exceeds the distance limit, the UE deletes the resume ID and context storage corresponding to the cell.

A fourth method: a storage number limit or a storage capacity limit, that is, when the UE stores resume IDs and contexts of a limited number of cells or a storage capacity arranged to store the resume IDs and the contexts, of the UE reaches the capacity limit, the UE does not store a resume ID and context of a new cell any more or the UE deletes the resume ID and context of the cell of which a utilization rate is minimum to store the resume ID and context of the new cell.

All of the second, third and fourth methods are adopted to reduce cost in resume ID and context storage of the UE.

Before the UE is prepared to initiate the RRC connection resume process in a certain cell, the UE queries whether it has ever reserved a resume ID allocated by the cell and a context storage corresponding to the cell, and if YES, the UE uses the resume ID allocated by the cell and the context storage corresponding to the cell for RRC connection resume.

### Eighth Example

If an RRC connection resume process initiated by UE fails or the UE fails to initiate an RRC connection reestablishment process, the UE does not delete a resume ID and corresponding context storage which are reserved by it. In addition, an eNB should also continue storing the resume ID and context storage corresponding to the UE and keep a context of the UE in a suspended state. The suspended state refers to that a context storage state of the UE is kept but an RRC connection of the UE is released.

From the above descriptions about the implementation modes, those skilled in the art may clearly know that the method according to the abovementioned embodiments may be implemented in a manner of combining software and a necessary universal hardware platform, and of course, may also be implemented through hardware, but the former is a preferred implementation mode under many circumstances. Based on such an understanding, the technical solutions of the disclosure substantially or parts making contributions to the conventional art may be embodied in form of software product, and the computer software product is stored in a storage medium (for example, a Read-Only Memory (ROM)/Random Access Memory (RAM), a magnetic disk and an optical disk), including a plurality of instructions configured to enable a computer device (which may be a personal computer, a server, a network device or the like) to execute the method in each embodiment of the disclosure.

### Second Embodiment

The embodiment further provides a device for acquiring a resume ID, which is configured to implement the abovementioned embodiments and preferred implementation modes. What has been described will not be elaborated. For example, term “module”, used below, may implement a combination of software with preset functions or may implement a combination of software and hardware with preset functions or may implement a combination of hardware with preset functions. Although the devices described in the following embodiment are preferably implemented with software, implementation with hardware or a combination of the software and the hardware is also possible and conceivable.

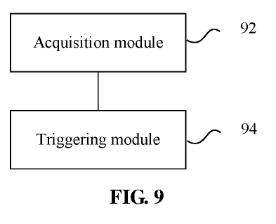

FIG. 9 is a first structure block diagram of a device for acquiring a resume ID according to an embodiment of the disclosure. As shown in FIG. 9, the device includes an acquisition module 92 and a triggering module 94.

The acquisition module 92 is configured to, before an RRC connection suspension process or an RRC connection release process is initiated, acquire a resume ID from a first access network device, the resume ID being configured to resume an RRC connection between UE and the first access network device and the resume ID corresponding to context information locally stored in the first access network device.

The triggering module 94 is connected with the acquisition module 92 and is configured to trigger an RRC connection resume request to be sent to a second access network device under at least one of the following triggering conditions, the second access network device being an access network device of a cell selected by the first access network device or by the UE: the RRC connection of the UE is released by the first access network device, the RRC connection of the UE is denied by the first access network device, an RLF occurs on the UE, a handover failure occurs on the UE, an integrity check failure occurs on the UE, an RRC connection reconfiguration failure occurs on the UE, or an RRC connection reestablishment process failure occurs on the UE.

By the device, since the resume ID is acquired before the RRC connection suspension process or the RRC connection release process, the resume ID may also be acquired even if an abnormal event, for example, an RLF and a handover failure, occurs before RRC release and the RRC connection may further be subsequently resumed. Therefore, the problem in the related art that an RRC connection resume mechanism may not resume the RRC connection if the abnormal event occurs before RRC release due to the fact that the resume ID is acquired in an RRC release process is solved and robustness of the RRC connection resume mechanism is improved.

It is to be noted that, according to the device, a conventional RRC connection setup process is not required to be executed for connection reestablishment after an RRC connection reestablishment failure, so that a signaling overhead is further reduced and, in addition, the RRC connection is resumed.

It is to be noted that the acquisition module 92 may exist independently, may also solve the technical problem and may further be connected with the triggering module 94, as shown in FIG. 9.

It is to be noted that the context information may include at least one of an AS context of the UE, an NAS context of the UE, an S1 interface control-plane context or an S1 interface user-plane context.

It is to be noted that the acquisition module 92 may acquire the resume ID in at least one of the following manners: acquisition through an RRC connection setup message, acquisition through a security mode command, acquisition through an RRC connection reconfiguration message, acquisition through an RRC connection reestablishment message, acquisition through a UE capability enquiry message, acquisition through a UE information request message, acquisition through a mobility from E-UTRA command, acquisition through a DL information transfer message, acquisition through a newly added RRC message, acquisition through an RRC connection reestablishment denial message, or acquisition through an RRC connection denial message.

It is to be noted that, when the RRC connection reestablishment process failure occurs on the UE, the UE notifies RRC reestablishment failure information to the NAS of the UE, and the NAS determines time for initiating the RRC connection resume process and, responsive to determining to initiate the RRC connection resume process, triggers the RRC connection resume request to be sent to the second access network device. In such a manner, RRC reestablishment may also be performed at first according to a conventional art after another triggering condition except the triggering condition that the RRC connection reestablishment process failure occurs on the UE occurs, and the RRC connection is resumed after a reestablishment failure. Therefore, RRC connection reestablishment and RRC connection setup processes in the conventional art may further be replaced with the method.

In an embodiment of the disclosure, the triggering module 94 is further configured to, when the triggering condition is that the RRC connection reestablishment process failure occurs on the UE, send information configured to indicate the RRC connection reestablishment process failure an NAS of the UE and, responsive to determining to initiate an RRC connection resume process, send the RRC connection resume request to the access network device.

It is to be noted that the UE reserves at least one of a resume ID acquired by the UE and allocated for the UE by each cell or context information, corresponding to each cell, of the UE.

In an embodiment of the disclosure, the device further includes a storage module arranged to, after the resume ID is acquired from the first access network device, set up and store the context information, corresponding to the first access network device, of the UE.

It is to be noted that the device may further include a query module, connected with the triggering module 94 and configured to, before the RRC connection resume request is sent to the second access network device, query whether the UE stores a resume ID allocated for the UE by the cell where the second access network device is located and the context information corresponding to the cell where the second access network device is located.

It is to be noted that the acquisition module 92 is further configured to, in a handover process of the UE, acquire a resume ID allocated for the UE by a source cell from an RRC connection reconfiguration message sent from the source cell and configured to indicate handover or acquire at least one of a resume ID allocated for the UE by a target cell or context information configured for the UE by the target cell from the RRC connection reconfiguration message sent from the source cell.

In an embodiment of the disclosure, the device may further include a sending module arranged to, in a process of performing RRC connection with the target cell using the RRC connection resume process, the resume ID allocated for the UE by the source cell is sent to an access network device of the target cell; or, the resume ID allocated for the UE by the target cell is sent to the access network device of the target cell.

In an embodiment of the disclosure, the device further includes a storage module arranged to, under the condition of an RRC connection resume failure, or the RRC connection reestablishment failure or the handover failure, when signaling including indication information configured to indicate that a resume ID and context information corresponding to a present cell are required to be deleted is not received from the first access network device, store the resume ID and context information and keep the UE in a suspended state, the suspended state referring to that the context storage of the UE in the present cell is kept but the RRC connection of the UE is released; or, under the condition of the RRC connection resume failure, the RRC connection reestablishment failure or the handover failure, if signaling including indication information configured to indicate that the resume ID and context information corresponding to the present cell are required to be suspended or kept is received from the first access network device, continue storing the resume ID and context storage corresponding to the present cell and keep the UE in the suspended state, otherwise delete the resume ID and context information of the present cell. The suspended state includes that the context storage of the UE in the present cell is kept but the RRC connection of the UE is released. The signaling includes at least one of an RRC connection resume denial message, an RRC connection resume failure message, the RRC connection reestablishment denial message or the RRC connection reconfiguration message.

It is to be noted that the sending module is further configured to send a notification message to the NAS of the UE, the notification message containing RRC connection resume failure information and RRC connection reestablishment failure information.

The RRC connection resume failure information includes at least one of a result or cause of the RRC connection resume failure.

The RRC connection reestablishment failure information includes at least one of a result or cause of the RRC connection reestablishment failure.

In an embodiment of the disclosure, the device may further include a deletion module arranged to, after a local storage time of the context information in the UE exceeds a predetermined time, delete at least one of the resume ID or the context information; or, when a movement location of the UE goes beyond a predetermined area coverage corresponding to a specified cell, delete at least one of a resume ID allocated for the UE by the specified cell or context information; or, when a number of at least one of the resume ID or context information stored in the UE exceeds a predetermined number, delete at least one of the resume ID allocated for the UE by the specified cell or the context information corresponding to the specified cell, or not store at least one of a resume ID allocated for the UE by a new cell or context information corresponding to the new cell any more, the specified cell being a cell of which a utilization frequency for the UE is lower than a predetermined frequency; or, when a storage space of the UE, which is configured to store at least one of the resume ID or the context information, exceeds a predetermined capacity, delete at least one of the resume ID allocated for the UE by the specified cell or the context information corresponding to the specified cell, or not store at least one of the resume ID allocated for the UE by the new cell or the context information corresponding to the new cell any more, the specified cell being the cell of which the utilization frequency for the UE is lower than the predetermined frequency.

It is to be noted that the condition that the movement location of the UE goes beyond the predetermined area coverage corresponding to the specified cell includes at least one of that: the UE and the specified cell are not in a same TA; the UE and the specified cell are not in a same LA; the UE and the specified cell are not in a same RA; the specified cell is not in a habitual movement range of the UE, herein the habitual movement range is a cell that the UE passes by or connects to for a number of times exceeding a predetermined number of times; or a distance between a present location of the UE and the specified cell exceeds a predetermined threshold value.

During a practical application, the sending module may be implemented by a communication interface (network interface) in the device for acquiring a resume ID, the acquisition module 92 may be implemented by a processor in combination with the communication interface in the device for acquiring a resume ID, the triggering module 94, the query module, the storage module and the deletion module may be implemented by the processor in the device for acquiring a resume ID and the storage module may be implemented by the processor in the device for acquiring a resume ID in combination with a memory.

It is to be noted that the device may be located in, but not limited to, the UE.

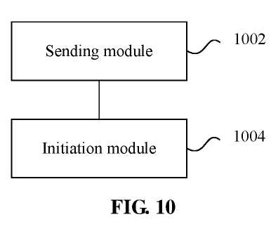

The embodiment also provides a device for sending a resume ID. FIG. 10 is a second structure block diagram of a device for sending a resume ID according to an embodiment of the disclosure. As shown in FIG. 10, the device includes a sending module 1002 and an initiation module 1004.

The sending module 1002 is configured to send a resume ID to UE, the resume ID being configured to resume an RRC connection between the UE and an access network device and the resume ID corresponding to context information locally pre-stored in the access network device.

The initiation module 1004 is connected with the sending module 1002 and is configured to initiate an RRC connection suspension process or an RRC connection release process.

By the device, since the resume ID is acquired before the RRC connection suspension process or the RRC connection release process, the resume ID may also be sent to the UE even if an abnormal event, for example, an RLF and a handover failure, occurs before RRC release and the RRC connection may further be subsequently resumed. Therefore, the problem in the related art that an RRC connection resume mechanism may not resume the RRC connection if the abnormal event occurs before RRC release due to the fact that the resume ID is acquired in an RRC release process is solved and robustness of the RRC connection resume mechanism is improved.

It is to be noted that, according to the device, a conventional RRC connection setup process is not required to be executed for connection reestablishment after an RRC connection reestablishment failure, so that a signaling overhead is further reduced and, in addition, the RRC connection is resumed.

It is to be noted that the context information may include at least one of an AS context of the UE, an NAS context, an S1 interface control-plane context or an S1 interface user-plane context.

According to the device, the context information corresponding to the resume ID is locally stored in both of the access network device and the UE. In such case, during RRC connection resume, since preparations have been made, that is, the context information is backed up, the RRC connection may further be resumed. Therefore, the robustness of the RRC connection resume mechanism is enhanced and the problem of poor robustness of the RRC connection resume mechanism in the related art is solved.

It is to be noted that the sending module 1002 sends the resume ID to the UE through at least one of: sending through an RRC connection setup message, sending through a security mode command, sending through an RRC connection reconfiguration message, sending through an RRC connection reestablishment message, sending through a UE capability enquiry message, sending through a UE information request, sending through a mobility from E-UTRA command, sending through a DL information transfer message, sending through a newly added RRC message, sending through an RRC connection reestablishment denial message, or sending through an RRC connection denial message.

In an embodiment of the disclosure, the device further includes a notification module arranged to send at least one of the following IDs to an MME: the resume ID, an ID configured to identify that the access network device has set up or suspended a context storage of the UE, or an ID configured to identify that the MME is required to set up or suspend the context storage of the UE.

In the solution, the sending module 1002 is further configured to execute the following operations: in an X2-interface-based handover process, sending a handover request to a target cell, the handover request including a resume ID allocated by a source cell for the UE to be handed over; in the X2-interface-based handover process, sending a handover request ACK to the source cell, the handover request ACK including a resume ID allocated by the target cell for the UE to be handed over; in an S1-interface-based handover process, sending a handover required message to the MME, the handover required message including the resume ID allocated by the source cell for the UE to be handed over; in the S1-interface-based handover process, acquiring the resume ID allocated by the source cell for the UE to be handed over from the handover request sent from the MME; in the S1-interface-based handover process, sending the handover request ACK to the MME through an S1 interface, the handover request ACK including the resume ID allocated by the target cell for the UE to be handed over; in the S1-interface-based handover process, acquiring the resume ID allocated by the target cell for the UE to be handed over from a handover command sent from the MME; in the X2-interface-based or S1-interface-based handover process, forwarding the resume ID allocated for the UE by the target cell to the UE through the RRC connection reconfiguration message configured to indicate handover; and in the X2-interface-based or S1-interface-based handover process, sending the resume ID allocated by the source cell to the UE through the RRC connection reconfiguration message configured to indicate handover.

In an embodiment of the disclosure, the device further includes a first receiving module arranged to, in the X2-interface-based handover process, receive the handover request ACK sent from the access network device of the target cell, the handover request ACK including context information configured for the UE by the target cell, and the context inform configured for the UE by the target cell is forwarded to the UE through the RRC connection reconfiguration message configured to indicate handover; or in the S1-interface-based handover process, receive the handover command sent from the MME to acquire the context information configured for the UE by the target cell and the context information configured for the UE by the target cell is forwarded to the UE through the RRC connection reconfiguration message configured to indicate handover, the MME acquiring the context information configured for the UE by the target cell through the handover request ACK sent from the access network device of the target cell.

In an embodiment of the disclosure, the device further includes a second receiving module arranged to receive an RRC connection resume request sent from the UE; a determination module, connected with the second receiving module and configured to determine whether the resume ID is a resume ID allocated for the UE by a present cell; a searching module, connected with the determination module and configured to, if YES, search contexts pre-stored in the access network device for the context information corresponding to the UE; and a requesting module arranged to, if NO, request the context information corresponding to the resume ID through an X2 interface or the S1 interface from a cell allocating the resume ID.

In an embodiment of the disclosure, the device further includes a storage module arranged to, under the condition of an RRC connection resume failure, an RRC connection reestablishment failure or a handover failure, store the resume ID and context information corresponding to the UE and keep the UE in a suspended state, the suspended state including that the RRC connection of the UE is released but the context information of the UE is stored. The sending module 1002 is further configured to, under the condition of the RRC connection resume failure, the RRC connection reestablishment failure or the handover failure, include a suspension indication or a context storage reservation indication in signaling sent to the UE to require the UE to continue storing the resume ID and context storage corresponding to the present cell and keep the UE in the suspended state, the signaling including at least one of an RRC connection resume denial message, an RRC connection resume failure message, the RRC connection reestablishment denial message or the RRC connection reconfiguration message.

In an embodiment of the disclosure, the device further includes a deletion module arranged to, under the condition of the RRC connection resume failure, the RRC connection reestablishment failure or the handover failure, send the signaling to notify the UE to delete the resume ID and context storage corresponding to the present cell and the resume ID and context storage locally stored in the access network device and corresponding to the UE are simultaneously deleted. The signaling includes at least one of the RRC connection resume denial message, the RRC connection resume failure message, the RRC connection reestablishment denial message or the RRC connection reconfiguration message.

During a practical application, the sending module 1002, the notification module and the requesting module may be implemented by a processor in combination with a communication interface (network interface) in the device for sending a resume ID, the initiation module 1004, the determination module, the searching module and the deletion module may be implemented by the processor in the device for sending a resume ID, the first receiving module and the second receiving module may be implemented by the communication interface in the resume ID sending module and the storage module may be implemented by the processor in the device for sending a resume ID in combination with a memory.

It is to be noted that the device may be located in, but not limited to, the access network device.

It is to be noted that each of the abovementioned modules may be implemented through software or hardware and the latter condition may be implemented in, but not limited to, the following manner: all of the modules are located in the same processor or each module is freely combined for location in different processors respectively.

### Third Embodiment

The embodiment further provides UE, which includes the device of the embodiment shown in FIG. 9. Explanations about the device may refer to the descriptions in the second embodiment and will not be elaborated herein.

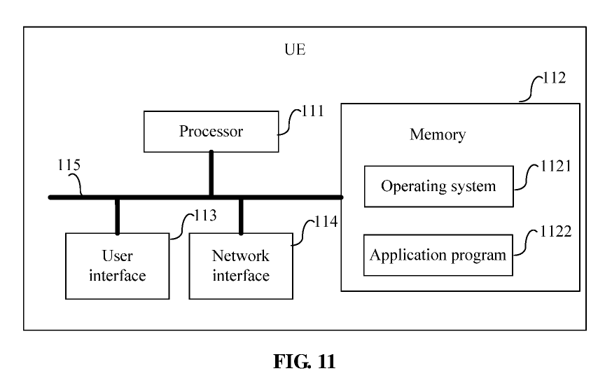

On such a basis, as shown in FIG. 11, the UE includes at least one processor 111, a memory 112, at least one network interface 114 and a user interface 113. Each component in the UE is coupled together through a bus system 115. It is to be understood that the bus system 115 is configured to implement connections and communications between these components. The bus system 115 includes a data bus and further includes a power bus, a control bus and a state signal bus. However, for clear description, various buses in FIG. 11 are marked as the bus system 115.

The user interface 113 may include a display, a keyboard, a button or a clicking device, for example, a mouse, a trackball, a touch panel or a touch screen.

It can be understood that the memory 112 in the embodiment of the disclosure may be a volatile memory or a nonvolatile memory, or may include both the volatile and nonvolatile memories.

In some implementation modes, the memory 112 stores the following elements, executable modules or data structures, or a subset thereof or an extended set thereof:

an operating system 1121 and an application program 1122.

In the embodiment of the disclosure, the processor 111 is configured to, before a first access network device initiates an RRC connection suspension process or an RRC connection release process, acquire a resume ID from the first access network device by use of the network interface 114, the resume ID being configured to resume an RRC connection between the UE and the first access network device and the resume ID corresponding to context information locally stored in the first access network device.

The processor 111 is further configured to trigger an RRC connection resume request to be sent to a second access network device under at least one of the following triggering conditions, the second access network device being an access network device of a cell selected by the first access network device or by the UE:

the RRC connection of the UE is released by the first access network device,

the RRC connection of the UE is denied by the first access network device,

a Radio Link Failure (RLF) occurs on the UE,

a handover failure occurs on the UE,

an integrity check failure occurs on the UE,

an RRC connection reconfiguration failure occurs on the UE, or

an RRC connection reestablishment process failure occurs on the UE.

The processor 111 is further configured to, before the RRC connection resume request is sent to the second access network device, query whether the UE stores a resume ID allocated for the UE by the cell where the second access network device is located and the context information corresponding to the cell where the second access network device is located.

In addition, after the resume ID is acquired from the first access network device, the processor 111 sets up and stores the context information, corresponding to the first access network device, of the UE to the memory 112 for subsequent processing.

Of course, the processor 111 is required to read information in the memory 112 and realize its function in combination with hardware thereof.

Specific functions of the processor 111, the memory 112 and the network interface 114 may refer to the descriptions in the second embodiment and will not be elaborated herein.

The embodiment further provides an access network device, which includes the device of the embodiment shown in FIG. 10. Explanations about the device may refer to the descriptions in the second embodiment and will not be elaborated herein.

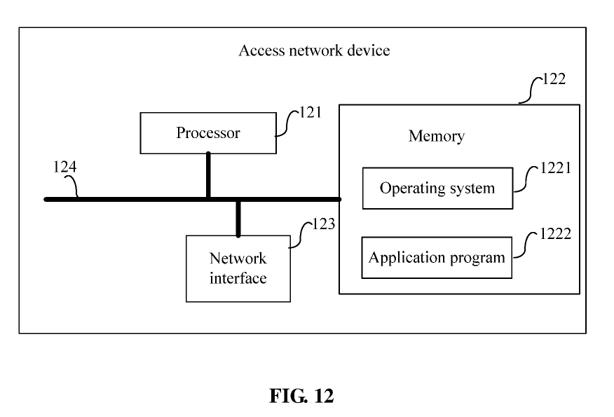

On such a basis, as shown in FIG. 12, the access network device includes at least one processor 121, a memory 122 and at least one network interface 123. Each component in the eNB is coupled together through a bus system 124. It is to be understood that the bus system 124 is configured to implement connections and communications between these components. The bus system 124 includes a data bus and further includes a power bus, a control bus and a state signal bus. However, for clear description, various buses in FIG. 12 are marked as the bus system 124.

It can be understood that the memory 122 in the embodiment of the disclosure may be a volatile memory or a nonvolatile memory, or may include both the volatile and nonvolatile memories.

In some implementation modes, the memory 122 stores the following elements, executable modules or data structures, or a subset thereof or an extended set thereof:

an operating system 1221 and an application program 1222.

In the embodiment of the disclosure, the processor 121 is configured to, before a first access network device initiates an RRC connection suspension process or an RRC connection release process, send a resume ID to UE by use of the network interface 123, the resume ID being configured to resume an RRC connection between the UE and the first access network device and the resume ID corresponding to context information locally stored in the access network device.

The processor 121 is further configured to send at least one of the following IDs to an MME by use of the network interface 123: the resume ID, an ID configured to identify that the access network device has set up or suspended a context storage of the UE, or an ID configured to identify that the MME is required to set up or suspend the context storage of the UE.

In addition, the processor 121 is further configured to:

in an X2-interface-based handover process, send a handover request to a target cell by use of the network interface 123, the handover request including a resume ID allocated by a source cell for the UE to be handed over;

in the X2-interface-based handover process, send a handover request ACK to the source cell by use of the network interface 123, the handover request ACK including a resume ID allocated by the target cell for the UE to be handed over;

in an S1-interface-based handover process, send a handover required message to the MME using the network interface 123, the handover required message including the resume ID allocated by the source cell for the UE to be handed over;

in the S1-interface-based handover process, acquire, using the network interface 123, the resume ID allocated by the source cell for the UE to be handed over from the handover request sent from the MME;

in the S1-interface-based handover process, send the handover request ACK to the MME using the network interface 123 and further through an S1 interface, the handover request ACK including the resume ID allocated by the target cell for the UE to be handed over;

in the S1-interface-based handover process, acquire, using the network interface 123, the resume ID allocated by the target cell for the UE to be handed over from a handover command sent from the MME;

in the X2-interface-based or S1-interface-based handover process, forward, using the network interface 123, the resume ID allocated for the UE by the target cell to the UE through the RRC connection reconfiguration message configured to indicate handover; and

in the X2-interface-based or S1-interface-based handover process, send, using the network interface 123, the resume ID allocated by the source cell to the UE through the RRC connection reconfiguration message configured to indicate handover.

The memory 122 stores the resume ID and context information corresponding to the UE for the processor 121 to use when necessary.

Of course, the processor 121 is required to read information in the memory 122 and realize its function in combination with hardware thereof.

Specific functions of the processor 121, the memory 122 and the network interface 123 may refer to the descriptions in the second embodiment and will not be elaborated herein.

### Fourth Embodiment

The embodiment of the disclosure further provides a computer storage medium. During a practical application, the computer storage medium in the embodiment may be configured to store a program code configured to execute the operations of the methods shown in the first embodiment.

In other words, the embodiment of the disclosure further provides a computer storage medium, which includes a set of instructions. The instructions are executed to cause at least one processor to execute the method for acquiring a resume ID described in the embodiments of the disclosure or execute the method for sending a resume ID described in the embodiments of the disclosure.

In an embodiment, in the embodiment, the storage medium may include, but not limited to: various media capable of storing program codes such as a U disk, a ROM, a RAM, a mobile hard disk, a magnetic disk or an optical disk.

In an embodiment, specific examples in the embodiment may refer to the examples described in the abovementioned embodiments and will not be elaborated in the embodiment.

Obviously, those skilled in the art should know that each module or each operation of the disclosure may be implemented by a universal computing device, and the modules or operations may be concentrated on a single computing device or distributed on a network formed by a plurality of computing devices, and in an embodiment, may be implemented by program codes executable for the computing devices, so that the modules or operations may be stored in a storage device for execution with the computing devices, the shown or described operations may be executed in sequences different from those described here in some circumstances, or may form each integrated circuit module respectively, or multiple modules or operations therein may form a single integrated circuit module for implementation. As a consequence, the disclosure is not limited to any specific hardware and software combination.

The above is only the preferred embodiment of the disclosure and not intended to limit the disclosure. For those skilled in the art, the disclosure may have various modifications and variations. Any modifications, equivalent replacements, improvements and the like made within the spirit and principle of the disclosure shall fall within the scope of protection of the disclosure.

### INDUSTRIAL APPLICABILITY

According to the embodiments of the disclosure, since the resume ID is acquired before the RRC connection suspension process or the RRC connection release process, the resume ID may also be acquired even if an abnormal event, for example, an RLF and a handover failure, occurs before RRC release and the RRC connection may further be subsequently resumed. Therefore, robustness of an RRC connection resume mechanism is improved.

1. A method for acquiring a resume Identifier (ID), comprising:
before a first access network device initiates a Radio Resource Control (RRC) connection suspension process or an RRC connection release process, acquiring a resume ID from the first access network device, the resume ID being configured to resume an RRC connection between User Equipment (UE) and the first access network device and the resume ID corresponding to context information locally stored in the first access network device.

2. The method of claim 1, wherein
the context information comprises at least one of an Access Stratum (AS) context of the UE, a Non-Access Stratum (NAS) context of the UE, an S1 interface control-plane context or an S1 interface user-plane context.

3. The method of claim 1, further comprising: after acquiring the resume ID from the access network device,
setting up and storing the context information, corresponding to the first access network device, of the UE.

4. The method of claim 1, wherein the resume ID is acquired in at least one of the following manners:
acquisition through an RRC connection setup message;
acquisition through a security mode command;
acquisition through an RRC connection reconfiguration message;
acquisition through an RRC connection reestablishment message;
acquisition through a UE capability enquiry message;
acquisition through a UE information request message;
acquisition through a mobility from Evolved Universal Terrestrial Radio Access (E-UTRA) command;
acquisition through a Downlink (DL) information transfer message;
acquisition through a newly added RRC message;
acquisition through an RRC connection reestablishment denial message; or
acquisition through an RRC connection denial message.

5. The method of claim 1, further comprising: after acquiring the resume ID from the first access network device, triggering an RRC connection resume request to be sent to a second access network device under at least one of the following triggering conditions, the second access network device being an access network device of a cell selected by the first access network device or by the UE:
the RRC connection of the UE is released by the first access network device;
the RRC connection of the UE is denied by the first access network device;
a Radio Link Failure (RLF) occurs on the UE;
a handover failure occurs on the UE;
an integrity check failure occurs on the UE;
an RRC connection reconfiguration failure occurs on the UE; or
an RRC connection reestablishment process failure occurs on the UE.

6. The method of claim 5, wherein, when the triggering condition is that the RRC connection reestablishment process failure occurs on the UE, triggering the RRC connection resume request to be sent to the second access network device comprises:
sending information configured to indicate the RRC connection reestablishment process failure to an NAS of the UE; and
responsive to determining to initiate an RRC connection resume process, sending, by the NAS of the UE, the RRC connection resume request to the second access network device.

7. The method of claim 5, wherein the UE reserves at least one of a resume ID acquired by the UE and allocated for the UE by each cell or context information corresponding to each cell.

8. The method of claim 5, further comprising: before sending the RRC connection resume request to the second access network device,
querying whether the UE stores a resume ID allocated for the UE by a cell where the second access network device is located and context information corresponding to the cell where the second access network device is located.

9. The method of claim 1, wherein, in a handover process of the UE, acquiring the resume ID from the first access network device comprises:
acquiring a resume ID allocated for the UE by a source cell from an RRC connection reconfiguration message sent from the source cell and configured to indicate handover; or
acquiring at least one of a resume ID allocated for the UE by a target cell or context information configured for the UE by the target cell from the RRC connection reconfiguration message sent from the source cell.

10. The method of claim 9, further comprising:
in a process of performing RRC connection with the target cell using the RRC connection resume process, sending the resume ID allocated for the UE by the source cell to an access network device of the target cell; or, sending the resume ID allocated for the UE by the target cell to the access network device of the target cell.

11. The method of claim 1, further comprising:
under the condition of an RRC connection resume failure, the RRC connection reestablishment failure or the handover failure, if signaling comprising indication information configured to indicate that a resume ID and context information corresponding to a present cell are required to be deleted is received from the first access network device, deleting the resume ID and context storage corresponding to the present cell, otherwise storing the resume ID and the context information and keeping the UE in a suspended state; or,
under the condition of the RRC connection resume failure, the RRC connection reestablishment failure or the handover failure, if signaling comprising indication information configured to indicate that the resume ID and context information corresponding to the present cell are required to be suspended or kept is received from the first access network device, continuing storing the resume ID and context storage corresponding to the present cell and keeping the UE in the suspended state, otherwise deleting the resume ID and context information of the present cell,
wherein the suspended state comprises that the context storage of the UE in the present cell is kept but the RRC connection of the UE is released; and
the signaling comprises at least one of an RRC connection resume denial message, an RRC connection resume failure message, the RRC connection reestablishment denial message or the RRC connection reconfiguration message.

12. The method of claim 11, further comprising:
sending a notification message to the NAS of the UE, wherein the notification message contains at least one of RRC connection resume failure information or RRC connection reestablishment failure information;
the RRC connection resume failure information comprises at least one of a result or cause of the RRC connection resume failure; and
the RRC connection reestablishment failure information comprises at least one of a result or cause of the RRC connection reestablishment failure.

13. The method of claim 1, further comprising:
after a local storage time of the context information in the UE exceeds a predetermined time, deleting at least one of the resume ID or the context information; or,
when a movement location of the UE goes beyond a predetermined area coverage corresponding to a specified cell, deleting at least one of a resume ID allocated for the UE by the specified cell or context information corresponding to the specified cell; or,
when a number of at least one of the resume ID or context information stored in the UE exceeds a predetermined number, deleting at least one of the resume ID allocated for the UE by the specified cell or the context information corresponding to the specified cell, or not storing at least one of a resume ID allocated for the UE by a new cell or context information corresponding to the new cell any more, the specified cell being a cell of which a utilization frequency for the UE is lower than a predetermined frequency; or,
when a storage space of the UE, which is configured to store at least one of the resume ID or the context information, exceeds a predetermined capacity, deleting at least one of the resume ID allocated for the UE by the specified cell or the context information corresponding to the specified cell, or not storing at least one of the resume ID allocated for the UE by the new cell or the context information corresponding to the new cell any more, the specified cell being a cell of which a utilization frequency for the UE is lower than the predetermined frequency.

14. The method of claim 13, wherein the condition that the movement location of the UE goes beyond the predetermined area coverage corresponding to the specified cell comprises at least one of that:
the UE and the specified cell are not in a same Tracking Area (TA);
the UE and the specified cell are not in a same Location Area (LA);
the UE and the specified cell are not in a same Routing Area (RA);
the specified cell is not in a habitual movement range of the UE, wherein the habitual movement range is a cell that the UE passes by or connects to for a number of times exceeding a predetermined number of times or a predetermined frequency; or
a distance between a present location of the UE and the specified cell exceeds a predetermined threshold value.

15.-23. (canceled)

24. A device for acquiring a resume Identifier (ID), comprising:
a memory storing processor-executable instructions; and
a processor arranged to execute the stored processor-executable instructions to perform a step of:
before a first access network device initiates an Radio Resource Control (RRC) connection suspension process or an RRC connection release process, acquiring a resume ID from the first access network device by use of the network interface, the resume ID being configured to resume an RRC connection between User Equipment (UE) and the first access network device and the resume ID corresponding to context information locally stored in the first access network device.

25. The device of claim 24, wherein the processor is arranged to execute the stored processor-executable instructions to further perform a step of: after acquiring the resume ID from the first access network device,
setting up and store the context information, corresponding to the first access network device, of the UE.

26. The device of claim 24, wherein the processor is arranged to execute the stored processor-executable instructions to further perform a step of: after acquiring the resume ID from the first access network device,
triggering an RRC connection resume request to be sent to a second access network device under at least one of the following triggering conditions, the second access network device being an access network device of a cell selected by the first access network device or by the UE:
the RRC connection of the UE is released by the first access network device;
the RRC connection of the UE is denied by the first access network device;
a Radio Link Failure (RLF) occurs on the UE;
a handover failure occurs on the UE;
an integrity check failure occurs on the UE;
an RRC connection reconfiguration failure occurs on the UE; or
an RRC connection reestablishment process failure occurs on the UE.

27. The device of claim 26, wherein the processor is arranged to execute the stored processor-executable instructions to further perform a step of: before sending the RRC connection resume request to the second access network device,
querying whether the UE stores a resume ID allocated for the UE by a cell where the second access network device is located and the context information corresponding to the cell where the second access network device is located.

28.-36. (canceled)

37. A computer storage medium, comprising a set of instructions that, when executed, cause at least one processor to execute a method for acquiring a resume Identifier (ID), the method comprising:
before a first access network device initiates a Radio Resource Control (RRC) connection suspension process or an RRC connection release process, acquiring a resume ID from the first access network device, the resume ID being configured to resume an RRC connection between User Equipment (UE) and the first access network device and the resume ID corresponding to context information locally stored in the first access network device.

38. The method of claim 7, further comprising: before sending the RRC connection resume request to the second access network device,
querying whether the UE stores a resume ID allocated for the UE by a cell where the second access network device is located and context information corresponding to the cell where the second access network device is located.
